(19) United States
(12) Patent Application Publication
(10) Pub. No.: US 2015/0081545 A1
(43) Pub. Date: Mar. 19, 2015

(54) SECURE PAYMENT BY MOBILE PHONE

(71) Applicant: GREG GISSLER, LOMETA, TX (US)

(72) Inventor: GREG GISSLER, LOMETA, TX (US)

(21) Appl. No.: 14/029,806

(22) Filed: Sep. 18, 2013

(51) Int. Cl. G06Q 20/40

(52) U.S. Cl. CPC G06Q 20/40145
USPC 705/44

(57) ABSTRACT

Some embodiments include a system and a method for making secure payments by mobile phone. Some embodiments identify and authorize payments without the need of any specialized payment transaction processing equipment other than a mobile phone for each of a consumer and a merchant engaged in the transaction. In some embodiments, a secure transaction payment authorization is performed by completing a set of voice biometrics operations to compare a unique voice print of the consumer to an existing voice print of the consumer.

### BACKGROUND

The embodiments herein relate generally to secure payments, and more particularly to making secure payments by mobile phones.

Non-cash payments for commercial transactions between consumers and merchants typically require authorization by a financial institution. For example, payment by credit card usually requires authorization for the payment amount before the transaction can be completed. In addition, non-cash payment methods must satisfy a threshold level of security. For instance, a point of sale debit card purchase may require that the consumer enters a personal identification number (PIN) to order to complete the sale. Conventional forms of non-cash payments, such as credit cards, debit cards, and checks, are well established and the equipment needed to handle such conventional non-cash payments are readily available to most merchants.

On the other hand, newer ways of making non-cash payments are becoming more widely considered by consumers to be legitimate ways of making payments. One newer form of payment is by mobile or cell phone. However, payment schemes involving the use of a cell phone require special equipment at the merchant location. This is problematic for many merchants who may not have sufficient budget to obtain such equipment, or who may not have sufficient space to install new equipment. In addition, these newer merchant transaction processing devices have a short history compared to equipment used in conventional non-cash transactions, and therefore, it is questionable whether the security of these newer devices is sufficient to maintain account privacy. Overall, having the possibility of account information being intercepted or hacked from a consumer's cell phone during a transaction makes many consumers leery of using them. This is problematic for merchants who may have incorporated such devices into their stores, and consumers who want the ability to complete payment transactions by cell phone.

Therefore, what is needed is a method to make payments by mobile phones to merchants and others whereby payment account selection and payment is securely authorized without the need of special equipment at the merchant location.

### BRIEF SUMMARY

Some embodiments of the invention include a system and a method for making secure payments by mobile phone. The system of some embodiments identifies and authorizes payments without the need of any specialized payment transaction processing equipment other than a mobile phone. In some embodiments, the system performs secure transaction payment authorizations by performing a set of voice biometrics operations to compare a unique voice print of the consumer to an existing voice signature of the consumer.

The method of some embodiments performs secure authentication by capturing a voice clip of the consumer, comparing the captured voice clip to an existing voice signature clip, and notifying the merchant of one of (i) approval when a set of biometric identifiers of the captured voice clip match a corresponding set of biometric identifiers of the voice signature clip and (ii) denial when at least one biometric identifier of the captured voice clip is different from the corresponding biometric identifier of the voice signature clip.

The preceding Summary is intended to serve as a brief introduction to some embodiments of the invention. It is not meant to be an introduction or overview of all inventive subject matter disclosed in this specification. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, and Drawings is needed. Moreover, the claimed subject matters are not to be limited by the illustrative details in the Summary, Detailed Description, and Drawings, but rather are to be defined by the appended claims, because the claimed subject matter can be embodied in other specific forms without departing from the spirit of the subject matter.

### BRIEF DESCRIPTION OF THE DRAWINGS

Having described the invention in general terms, reference is now made to the accompanying drawings, which are not necessarily drawn to scale, and wherein:

FIG. 1 conceptually illustrates an example of a secure mobile phone payment system of some embodiments.

FIGS. 2-3 conceptually illustrate example processes for making secure payments by mobile phone in some embodiments.

FIG. 4 conceptually illustrates an electronic system with which some embodiments of the invention are implemented.

### DETAILED DESCRIPTION

In the following detailed description, several examples and embodiments of the invention are described. However, it will be clear to a person skilled in the art that the invention is not limited to the embodiments set forth and can be adapted for any of several other security needs.

Some embodiments of the invention include a method and a system for making secure payments by mobile phone. The system and the method both allow a consumer to use a mobile phone to make a payment to a merchant or another selling entity associated with a payment transaction. In some embodiments, the consumer initiates a secure payment using the mobile phone by making a selection of an account from which to make payment and indicating a payment amount to be paid to the merchant or other selling entity. In some embodiments, the account selection and payment account are transmitted to a payment processing system that requests authorization from a financial institution associated with the selected account for secure authorization. The payment processing system thereafter transmits one of an approval and a denial to the merchant without the need of special equipment at the merchant location.

Several more detailed embodiments are described in the sections below. Section I describes a secure mobile phone payment system. Section II describes a method of some embodiments for making secure authorized payments by mobile phone. Next, Section III describes an electronic system with which some embodiments of the invention are implemented.

I. Secure Mobile Phone Payment System

In some embodiments, the system identifies and authorizes payments without the need of any specialized payment transaction processing equipment other than a mobile phone. In some embodiments, the system performs secure transaction payment authorizations by performing a set of voice biometrics operations to compare a unique voice print of the consumer to an existing voice signature of the consumer. In this way, no account information is ever transmitted over a network that is open to the general public, such as the Internet.

In some embodiments, the system for making secure payments by mobile phone comprises (i) a voice processing computing device that captures a voice clip of a consumer associated with a request to authorize a payment transaction to a merchant by a mobile phone of the consumer and compares the captured voice clip to an existing voice signature clip of the consumer to determine whether the payment transaction is approved or denied and (ii) a secure server that receives a set of consumer account information associated with a customer account of an authorizing financial institution and provides the existing voice signature clip to the voice processing computing device when the financial institution authorizes payment transaction based on the set of consumer account information.

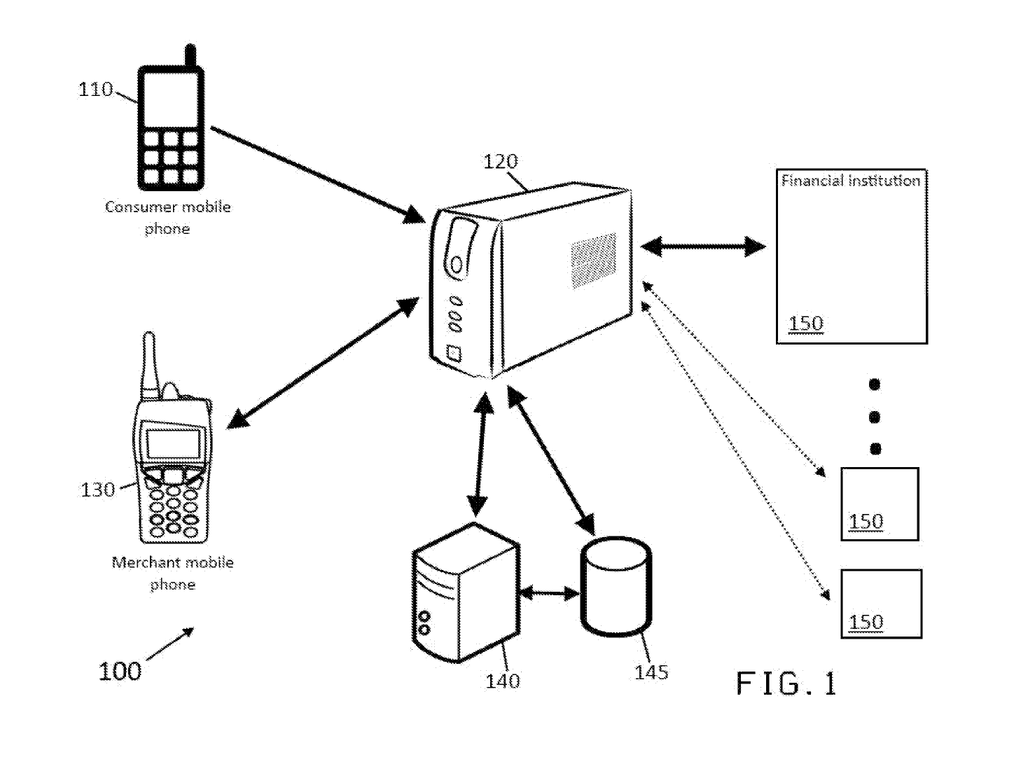

FIG. 1 conceptually illustrates an example of a secure mobile phone payment system of some embodiments. As shown in this figure, the system 100 comprises a consumer mobile phone 110, a voice processing server 120, a merchant mobile phone 130, a secure server 140, a database 145, and a set of financial institutions 150.

For the example illustrated in FIG. 1, the consumer cell phone 110 and the merchant cell phone 130 appear as different types of phones. In this case, the different appearances are only for illustration in order to differentiate different parties (i.e., the consumer, the merchant) who perform different operations that are possible from within the system 100. Moreover, both the consumer and merchant cell phones can be any type of mobile phone capable of establishing a cellular (i.e., GSM, CDMA, etc.) communication connection or other mobile connection with the voice processing server 120. In some embodiments, the merchant uses a computing device instead of a mobile phone 130.

In some embodiments, the consumer initially registers the cell phone 110 with a secure voice processing server 120 of the system 100. In doing so, for example, the consumer may provide a set of information to the server, such as credit cards, bank accounts, and other financial information related to accounts from which the consumer can make payments to merchants or others. In some embodiments, the voice processing server 120 captures a voice print of the consumer. In some embodiments, the voice print is based on a vocalization by the consumer into the cell phone 110 during registration. The audible vocalization by the consumer can be any utterance capable of being recognized in relation to another utterance of the consumer. By way of example, the consumer may vocalize digits of an account number which the consumer cell phone 110 captures as a voice print and thereafter transmits the captured voice print to the voice processing server 120 for storage and future access. For instance, the captured voice print can be stored during the registration process and subsequently accessed by the voice processing server 120 for account and identity validation operations.

In some embodiments, voice prints, cell phone identities, credit card accounts, bank accounts, and other consumer data is stored in a database 145 for persistent storage. In some embodiments, the voice print and other data is persisted in the database 145 by the secure server 140. For example, the secure server may include a database management software server that facilitates interaction with the database 145 and the data in the database. In some embodiments, the database 145 comprises a plurality of databases. Although only a single representation of a database is illustrated in this figure, a person skilled in the art would appreciate that multiple logicallly interconnected and/or physically separate databases can be used in the system. As such, in some of these embodiments, each database 145 is individually accessible exclusive of the other databases 145. In other of these embodiments, all of the databases are accessible together as a single logical database 145. Alternatively, or in conjunction with storing to the database 145, the voice processing server 120 of some embodiments stores the voice print and consumer data directly to at least one of a local hard disk and a cache memory of the voice processing server 120.

In some embodiments, the voice print of a consumer is both (i) stored in a local memory cache of the voice processing server 120 and (ii) persisted in the database 145, thereby allowing the voice processing server 120 to quickly access the voice print at runtime from cache and allowing one or more other servers to access the voice print from the database 145 storage. For instance, the secure mobile phone payment system 100 may include a redundant (i.e., backup) voice processing server that is configured to access the persistent database 145 storage as a failover server in the event of a problem, such as the voice processing server 120 becoming inaccessible (e.g., crashing, restarting for a scheduled update, etc.). In some embodiments, the voice processing server 120 accesses the database 145 through a database management software server operating on the secure server 140. For example, a relational database management system (RDBMS) operating on the secure server 140 may facilitate access to the database 145, which may be deployed as a local resource of the secure server 140, a local resource of the voice processing server 120, and/or a networked resource accessible over a network to which the voice processing server and the secure server connect. Although an RDBMS is exemplified above, any kind of database management system (e.g., RDBMS, object database management system (ODBMS), etc.) may be operational on the secure server or on another server of the system 100.

In some embodiments, one or both of the voice processing server 120 and the secure server 140 communicate with one or more software applications by way of an application programming interface (API). In some of these embodiments, the software applications include a set of API calls for interacting with the server. For instance, a set of API calls may be directed to a database management system operating on the secure server for accessing persistent data from and storing data to the database 145. Likewise, software applications operating on the voice processing server 120 may be configured to access persistent data from and store data to a local file system of an operating system running on the voice processing server 120. For example, a voice print of a consumer can be stored as a file on a local file system (e.g., FAT, NTFC, NFS, SMB, etc.).

In some embodiments, the voice processing server 120 performs voice biometric and recognition operations to validate the authenticity of the consumer, the merchant, and a set of transaction-related financial information, including at least an account from which to establish a secure payment from the consumer to the merchant and a payment amount, which is reviewed for approval from a financial institution 150 associated with the account and is confirmed by the merchant. In some embodiments, the consumer cell phone 110 connects with the voice processing server 120 to initiate processing for a transaction. In some embodiments, a set of operations associated with the transaction are initiated after receiving a merchant ID from the consumer phone 110. In some embodiments, the merchant ID comprises a set of characters that uniquely identify the merchant. In some embodiments, the set of characters comprises numeric characters. In some embodiments, the characters comprises alphanumeric characters. For example, the consumer may use a keypad or a touchscreen of the cell phone to input a merchant ID (e.g., 34567, ES34567, etc.).

A merchant ID can be determined by a consumer in any manner. For instance, the merchant ID may be posted near a checkout register at a physical store of the merchant, and thus, provide convenient and accurate identity information at the point of sale. In some embodiments, the system 100 maintains a secure connection between the voice processing server 120 and the consumer phone 110 when the received merchant ID is validated. For example, the voice processing server may retrieve a set of data with merchant information associated with the received merchant ID. In this way, the system can validate the received merchant ID by comparing the received merchant ID to a set of merchant data retrieved from the database 145.

In some embodiments, the voice processing server 120 implements one or more of the operations as a software program for processing audible voice sounds. In some embodiments, a voice biometric software application and a voice recognition software application operate on the voice processing server 120 to process audible voice sounds In some embodiments, the voice processing server 120 also receives a vocalization of an account to use for the transaction. In some embodiments, the voice recognition software is used so that a consumer can vocalize the account from which to make payment. Upon recognizing the account, the voice processing server 120 of some embodiments securely connects to a financial institution 150 associated with the account. In some embodiments, a set of financial institutions are connected to in order to process payment. In some embodiments, the voice processing server 120 connects to one or more payment authorization systems of the financial institution. Contemporaneously with connecting to the payment authorization system of the financial institution 150, in some embodiments, the voice processing server 120 performs at least one additional validation operation. In some embodiments, the additional validation operation includes generating a phrase for the consumer to repeat back into the mobile phone. In some embodiments, the phrase is randomized to reduce risk and enhance integrity.

In some embodiments, the merchant uses the merchant cell phone 130 to register one or more receiving accounts with the voice processing server 120. In addition, the merchant registers a telephone number associated with the merchant mobile phone 130. If the merchant is not using a cell phone, but a computing device, the merchant registers another contact address to which the voice processing server can contact the merchant. For instance, an alternative to a cell phone number might be a land line telephone number at a physical location of the merchant, an email address accessible to the merchant via the computing device, and/or an identifier for receiving in-app messages from the voice processing server.

In some embodiments, the voice processing server 120 connects with the financial institution 150 while the other operations are being performed, as described above. In other embodiments, the voice processing server 120 connects to the secure server 140, which connects to one or more of the financial institutions 150. In either manner of connecting to a financial institution, no account information is ever transmitted due to account selection and authorization being done over a phone using voice biometrics and voice recognition to positively identify the user and confirm payment to the merchant. In this way, the system 100 safeguards identity and account information for any authorized mobile phone payment.

The example described above relates to a secure mobile phone payment system 100 in which a consumer uses a cell phone 110 to specify an account for payment and merchant ID, while the voice processing server 120 and secure server 140 determine whether two voice clips match by comparing an existing voice signature clip of the consumer to a voice clip contemporaneously received from the mobile phone 110 (e.g., to validate the identity of the consumer when the two voice clips match) of the consumer to validate the consumer's identity. In this way, authorization from a financial institution 150 for a payment debited from one or more consumer-specified accounts is based on a verified consumer using a mobile device. The next section describes processes in some embodiments for making secure payments by mobile phone.

II. Secure Payment by Mobile Phone Processes

In some embodiments, making secure payments by a mobile phone of a consumer to a mobile phone or a computing device of a merchant includes validating the authenticity of the consumer. In some embodiments, a process validates consumer authenticity by capturing a voice clip of the consumer, comparing the captured voice clip to a voice signature clip of the consumer, and notifying the merchant of either (i) approval when the captured voice clip sufficiently matches the voice signature clip or (ii) denial when the captured voice clip does not sufficiently match the voice signature clip. The consumer would make a payment at a merchant location or, alternatively, from a remote location when, for example, performing a virtual check out after viewing merchandise or service details on a website of the merchant.

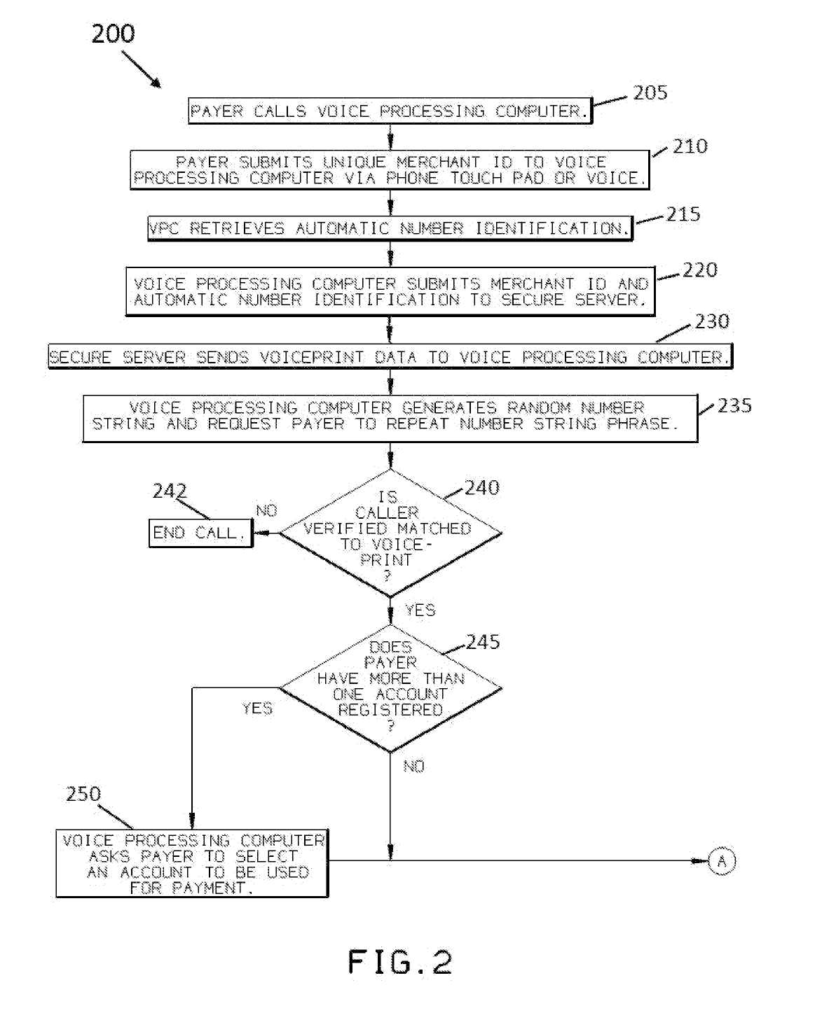

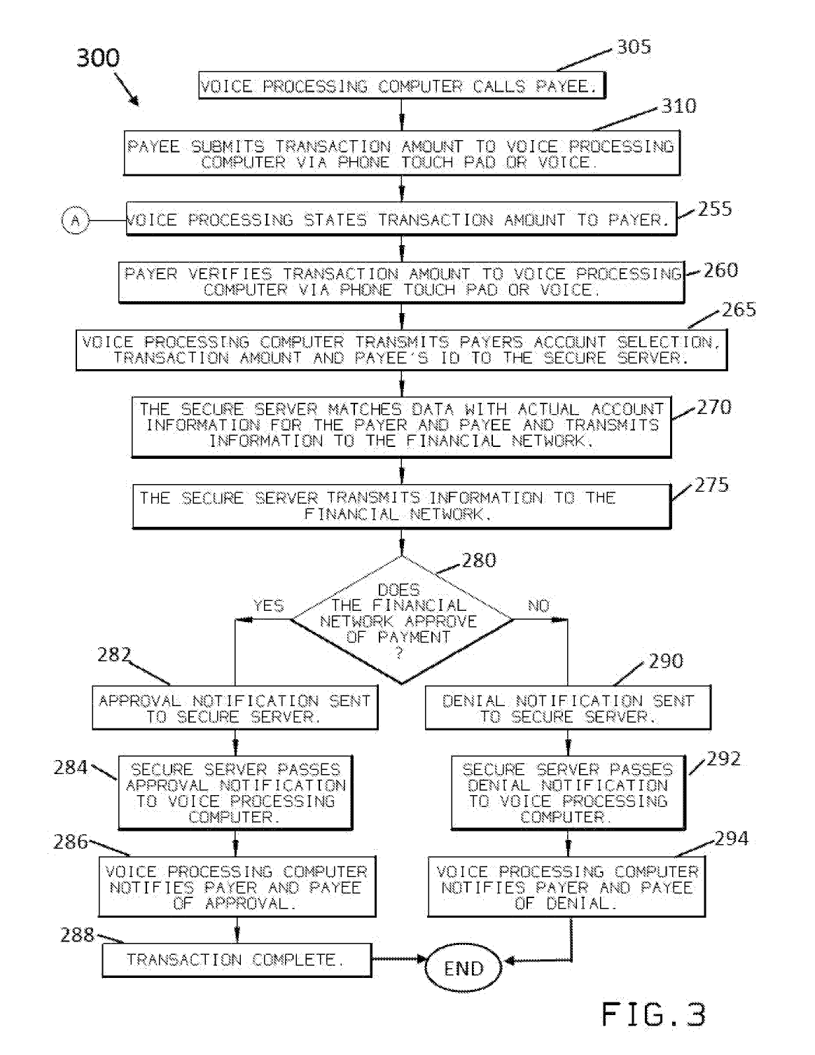

FIGS. 2-3 conceptually illustrate examples of processes for making secure payments via mobile phone. Specifically, FIG. 2 (including some steps that continue into FIG. 3) conceptually illustrates an example process 200 in which multiple levels of consumer authentication are used in making secure payments by mobile phone, while FIG. 3 (i.e., all steps in FIG. 3) conceptually illustrates an example process 300 for making secure payments by mobile phone in which a single level of consumer authentication is used. In some embodiments, the processes are implemented as software applications operating on computing devices that receive communications from the mobile phone of the consumer and communicate with the mobile phone or computing device of the merchant.

A. Multiple Levels of Consumer Authentication

Referring to FIG. 2, the process 200 starts when a consumer initiates a payment by mobile phone. In some embodiments, the process 200 receives (at 205) a call from a consumer. The consumer calls a voice processing server in some embodiments to either register (if not previously registered) or initiate a payment by the consumer's mobile phone. If the caller is registered, the process 200 next receives (at 210) a merchant ID from the consumer's mobile phone. In some embodiments, the consumer submits a unique combination of characters as the merchant ID. In some embodiments, the merchant ID is displayed at a cash register of the merchant store at which the consumer is initiating the transaction. In other embodiments, the merchant ID is displayed remotely. For instance, the consumer may be conducting a transaction over the Internet and may see the unique merchant ID on a website of the merchant. In some embodiments, the process 200 retrieves (at 215) a number identification based on the merchant ID submitted by the consumer. In some embodiments, the process automatically retrieves the number ID. For example, the process may access a look up table, stored in a file on the voice processing server or in the database, that associates the unique merchant ID with the number identification. In some embodiments, the process then submits (at 220) the merchant ID and the automatic number identification to a secure server. For instance, a secure server may have access to voice print files that the process can use to validate the identity of the consumer.

Next, the process receives (at 230) voice print data from the secure server. The process then generates (at 235) a random number string which in some embodiments is transmitted to the mobile phone of the consumer. The random number is generated in order to provide a validation of the consumer's cell phone. Thus, the random number can be any number, so long as it is sent to the mobile phone of the consumer. Once the random number is received at the consumer's mobile phone, the consumer is directed to call the voice processing server and repeat the random number string. When the consumer calls the voice processing server and states the random string characters, the process 200 determines (at 240) whether the voice print matches the voice of the consumer based on the sound of the consumer repeating the random string. If the process determines that the voice print does not match the caller's voice (i.e., repeating the random string), the process 200 ends. Otherwise, if the process determines that the voice print matches the caller's voice, then the process 200 determines (at 245) whether the consumer associated with the matched voice print has only one account. If the process determines that the consumer has more than one account registered, the process transmits a request (at 250) to the mobile phone of the consumer to select one of the registered accounts to use for payment to the merchant for the present transaction. If only one account is registered, the process skips the request to select an account for payment. Instead, the process 200 automatically selects the sole registered account of the consumer from which to make payment for the present transaction.

The process 200 continues to entry point “A” in FIG. 3, at a step in which the process 200 performs a transaction verification. Specifically, the process 200 verifies the transaction amount by transmitting (at 255) to the mobile phone of the consumer a request to verify payment amount. For example, the voice processing server may send a text message for simple verification with the message stating “Transaction Total: $300.00. Press 1 to confirm. Press 2 to deny.” Any request text or any amount (not just $300.00) can be communicated to the consumer for verification. The process 200 then receives (at 260) a verification from the mobile phone of the consumer. The consumer can input the appropriate response via a keypad or touch screen of the mobile phone.

After transaction amount verification, the process 200 transmits (at 265) the selected account (i.e., the consumer-selected account when more than one account is registered or the automatically selected sole account), the transaction amount, the merchant ID, and the consumer's verified identification to the secure server. The secure server then matches (at 270) the transmitted data with previously verified account information associated with the consumer and the selected account, as well as known account information for the merchant. After matching is complete, the secure server transmits (at 275) the information to the financial network or institution.

The process 200 next determines (at 280) whether the financial institution approves of the payment from the consumer's account to the merchant. In some embodiments, if the payment is not approved, the process performs a set of transaction denial operations, which are described further below. However, if payment is approved, the process sends (at 282) an approval notification to the secure server, which transmits (at 284) the approval notification to the voice processing server. The process 200 then notifies (at 286) both the consumer and merchant of approval. For example, the voice processing server may send a text message to the mobile phone of the consumer indicating that the payment is approved, and send another message to the mobile phone (or other computing device) of the merchant indicating that the financial institution approved payment by consumer for the stated transaction amount. Then the transaction between the consumer and the merchant is complete (at 288) and the process 200 ends.

Referring back to the determination (at 280) of whether the financial institution approves of the payment, when payment is not approved, the process 200 receives a denial notification (at 290) sent to the secure server, which then passes (at 292) the denial notification to the voice processing server. Next, the process 200 notifies (at 294) the consumer and merchant that payment for the transaction has been denied by the financial institution. The denial notification can be sent via SMS text message, email, etc. Then the process 200 ends.

B. Single Level of Consumer Authentication

In some embodiments, the voice processing server performs a single level of consumer authentication by calling the mobile device of the consumer after receiving a communication to initiate a transaction from the consumer mobile device. In some of these embodiments, a random string is not generated for transmission to the mobile device of the consumer as a subsequent level of consumer authentication. Instead, only a single level of consumer authentication is employed. FIG. 3 conceptually illustrates an example in which a single level of consumer authentication is used in making secure payments by mobile phone.

Specifically, the process 300 starts after a transaction has been initiated by a consumer. For example, a consumer has already called the voice processing server to initiate a transaction for paying a merchant by mobile phone, based on the merchant ID and the selected payment account provided by the consumer. In these embodiments, the process 300 calls (at 305) the mobile device of the merchant. As described by reference to FIG. 2 above, the voice processing server of some embodiments can call the mobile device of the merchant using any of several cellular and/or mobile communication protocols (e.g., GSM, CDMA, etc.).

Next, the process 300 receives (at 310) a transaction amount from the merchant, which is to be paid by the consumer to the merchant. In some embodiments, the process receives a text message or other character-based representation of the transaction amount from the mobile device of the merchant. For example, the merchant uses the keypad or a touch screen of the mobile device to input the transaction amount to be submitted for approval to the financial institution (and upon approval by the financial institution, for payment by the consumer to the merchant). In other embodiments, the process 300 receives an acoustic representation of the transaction amount. For example, the merchant audibly states the transaction amount. After receiving the transaction amount from the mobile device of the merchant, the process 300 transitions to 255, in which the voice processing server transmits a communication to the mobile device of the consumer which states the transaction amount received by the process 300 at 310. The process 300 continues from step 255 and continuing through step 294, each step of which is described above.

As the example process 300 illustrates, in some embodiments, a single level of consumer authentication can be employed. While this example does not include generation of a random string to be used as a second level of consumer authentication, a person of skill in the art would understand that in some embodiments, the process 300 can generate a random string to be repeated by the consumer as the only level of consumer authentication (instead of repeating the transaction amount). While the processes 200 and 300 are described by reference to a voice processing server and a secure server, in some embodiments, the voice processing server and the secure server operate on a single computing device.

II. Electronic System

Many of the above-described features and applications are implemented as software processes that are specified as a set of instructions recorded on a computer readable storage medium (also referred to as computer readable medium or machine readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

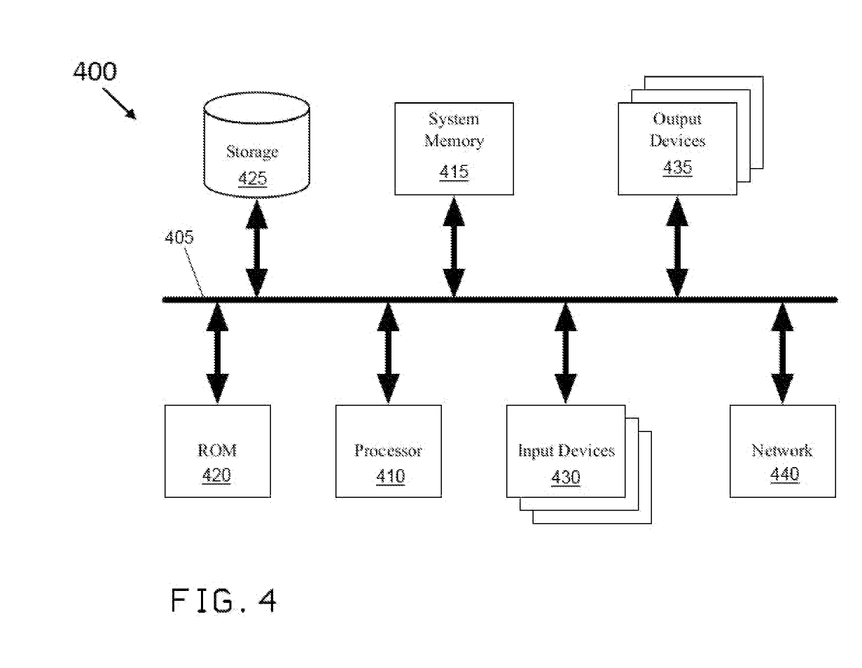

FIG. 4 conceptually illustrates an electronic system 400 with which some embodiments of the invention are implemented. The electronic system 400 may be a computer, phone, PDA, or any other sort of electronic device. Such an electronic system includes various types of computer readable media and interfaces for various other types of computer readable media. Electronic system 400 includes a bus 405, processing unit(s) 410, a system memory 415, a read-only 420, a permanent storage device 425, input devices 430, output devices 435, and a network 440.

The bus 405 collectively represents all system, peripheral, and chipset buses that communicatively connect the numerous internal devices of the electronic system 400. For instance, the bus 405 communicatively connects the processing unit(s) 410 with the read-only 420, the system memory 415, and the permanent storage device 425.

From these various memory units, the processing unit(s) 410 retrieves instructions to execute and data to process in order to execute the processes of the invention. The processing unit(s) may be a single processor or a multi-core processor in different embodiments.

The read-only-memory (ROM) 420 stores static data and instructions that are needed by the processing unit(s) 410 and other modules of the electronic system. The permanent storage device 425, on the other hand, is a read-and-write memory device. This device is a non-volatile memory unit that stores instructions and data even when the electronic system 400 is off. Some embodiments of the invention use a mass-storage device (such as a magnetic or optical disk and its corresponding disk drive) as the permanent storage device 425.

Other embodiments use a removable storage device (such as a floppy disk or a flash drive) as the permanent storage device 425. Like the permanent storage device 425, the system memory 415 is a read-and-write memory device. However, unlike storage device 425, the system memory 415 is a volatile read-and-write memory, such as a random access memory. The system memory 415 stores some of the instructions and data that the processor needs at runtime. In some embodiments, the invention's processes are stored in the system memory 415, the permanent storage device 425, and/or the read-only 420. For example, the various memory units include instructions for processing secure payments by mobile phone in accordance with some embodiments. From these various memory units, the processing unit(s) 410 retrieves instructions to execute and data to process in order to execute the processes of some embodiments.

The bus 405 also connects to the input and output devices 430 and 435. The input devices enable the user to communicate information and select commands to the electronic system. The input devices 430 include alphanumeric keyboards and pointing devices (also called “cursor control devices”). The output devices 435 display images generated by the electronic system 400. The output devices 435 include printers and display devices, such as cathode ray tubes (CRT) or liquid crystal displays (LCD). Some embodiments include devices such as a touchscreen that functions as both input and output devices.

Finally, as shown in FIG. 4, bus 405 also couples electronic system 400 to a network 440 through a network adapter (not shown). In this manner, the computer can be a part of a network of computers (such as a local area network (“LAN”), a wide area network (“WAN”), or an Intranet), or a network of networks (such as the Internet). Any or all components of electronic system 400 may be used in conjunction with the invention.

These functions described above can be implemented in digital electronic circuitry, in computer software, firmware or hardware. The techniques can be implemented using one or more computer program products. Programmable processors and computers can be packaged or included in mobile devices. The processes and logic flows may be performed by one or more programmable processors and by one or more set of programmable logic circuitry. General and special purpose computing and storage devices can be interconnected through communication networks.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the invention has been described with reference to numerous specific details, one of ordinary skill in the art will recognize that the invention can be embodied in other specific forms without departing from the spirit of the invention. For instance, many of the figures make reference to digital cell phones. However, a variety of other types of mobile computing devices capable of mobile communication are conceived, including tablet computing devices, hand-held computing devices, analog cell phones (in which analog voice signals received from the consumer's cell phone are converted into digital signals by, for example, an analog to digital converter of the voice processing server or another computing device of the system), and other mobile devices.

Also, FIG. 1 illustrates a schematic of a system for making secure payments by mobile phone. Certain elements associated with this schematic may not be organized in the system with exactly the same operational and functional relationships to other operational elements. For instance, in order not to obscure the schematic shown in FIG. 1 with unnecessary detail, certain system elements have not been illustrated, including, for example, certain communication elements (e.g., cell phone towers), network management elements, or administrative elements.

In addition, FIGS. 2 and 3 conceptually illustrate processes. The specific operations of these processes may not be performed in the exact order shown and described. Specific operations may not be performed in one continuous series of operations, and different specific operations may be performed in different embodiments. Furthermore, each of the processes could be implemented using several sub-processes, or as part of a larger macro process. Thus, one of ordinary skill in the art would understand that the invention is not to be limited by the foregoing illustrative details, but rather is to be defined by the appended claims.

We claim:

1. A non-transitory computer readable medium storing a program which when executed by at least one processing unit of a computing device strengthens password security, said program comprising sets of instructions for:
receiving an audio clip transmitted by a mobile phone of a consumer, said audio clip comprising a voice print of the consumer as captured by the mobile phone;
comparing the received audio clip to a pre-recorded voice print of the consumer; and
notifying the merchant of one of (i) approval when the captured voice clip sufficiently matches the voice signature clip and (ii) denial when the captured voice clip does not sufficiently match the voice signature clip.

2. The non-transitory computer readable medium of claim 1, wherein the consumer makes payment at a physical location of the merchant.

3. The non-transitory computer readable medium of claim 2, wherein the program further comprises a set of instructions for receiving a text message from the mobile phone of the consumer, said text message comprising a merchant ID.

4. The non-transitory computer readable medium of claim 3, wherein the merchant ID is a unique identifier that is associated with a particular merchant mobile phone.

5. The non-transitory computer readable medium of claim 4, wherein the program further comprises a set of instructions for generating a random string to be repeated back by the consumer for authentication.

6. The non-transitory computer readable medium of claim 5, wherein the random string comprises alphanumeric characters.

7. The non-transitory computer readable medium of claim 1, wherein the program further comprises a set of instructions for determining whether the consumer has at least two accounts registered, and when at least two accounts are registered, requesting a selection of a single account from which the consumer can pay for the transaction.

8. A system for making secure payment by mobile phone, said system comprising:
a mobile phone of a consumer associated with a transaction between the consumer and a merchant, the transaction initiated by the mobile phone of the consumer;
a voice processing server for validating the authenticity of the consumer in connection with a captured voice print that is compared to a pre-recorded voice signature print;
a database that stores voice print and other data in connection with the transaction; and
a mobile phone of a merchant for confirming an amount due when the voice processing server.

9. The system for making secure payment by mobile phone of claim 8, said system further comprising a secure server for providing a voice signature print to compare with the voice print of the consumer.

10. The system for making secure payment by mobile phone of claim 8, said system further comprising integrations with one or more financial institutions for making payment from.
